(19) United States
(12) Patent Application Publication
(10) Pub. No.: US 2025/0026906 A1
(43) Pub. Date: Jan. 23, 2025

(54) LOW EMISSIVITY MATERIALS AND ASSOCIATE METHODS

(71) Applicant: Neverfrost Inc., Kitchener (CA)

(72) Inventors: Amogha Ravindra, Kitchener (CA); Tina Lettner, Kitchener (CA); Chong Shen, Kitchener (CA)

(21) Appl. No.: 18/712,673

(22) PCT Filed: Nov. 23, 2022
(86) PCT No.: PCT/CA2022/051724

§ 371 Date: May 22, 2024

Related U.S. Application Data
(60) Provisional application No. 63/282,436, filed on Nov. 23, 2021.

(51) Int. Cl. C08K 3/08; D06M 15/19; D06M 23/10

(52) U.S. Cl. CPC C08K 3/08; D06M 15/19; D06M 23/10; C08K 2003/0806; C08K 2003/0812; C08K 2003/0831; C08K 2003/085; C08K 2003/0856; C08K 2201/001; C08K 2201/011

(57) ABSTRACT

A low emissivity material and associated methods are provided. Provided is a low emissivity material comprising a low emissivity pigment, the pigment comprising a conductive nanomaterial and a resin. The pigment is dispersed into the resin, forming a matrix of conductive nanomaterial. Provided is a method of producing a low emissivity material comprising dispersing a low emissivity conductive nanomaterial pigment into a resin, to produce the low emissivity material.

### TECHNICAL FIELD

Discloses in herein generally are compositions of low emissivity materials and associated methods, and in particular, materials that incorporate conductive metallic nanomaterials to improve the overall emissivity characteristics of a material or coating comprising the material, and associated methods.

### INTRODUCTION

Nanocoatings are widely used in a variety of industries due to their ability to impart a variety of material properties such as abrasion-resistance, mechanical strength, chemical resistance, thermal stability, weatherability, and others. Single or multiple layers of polymer coatings may be applied as a thin film to the surface of furniture, automotive surfaces, glass, toys, floors and other substrates to improve functionality and longevity of such substrates. Such thin films are commonly referred to as “nano coatings” as the thickness of the layer(s) range from tens to hundreds of nanometers, and/or due to the presence of nanoscale sized particles dispersed throughout the polymer.

Specifically, such nano coatings and the pigments they contain may comprise low emissivity characteristics that are of interest in a variety of industries, such as automotive, military, agriculture, and construction. For example, the use of camouflage is an essential method used by the military in order to protect personnel and equipment in the field. The use of increasingly advanced thermal imaging detection methods poses a significant threat to soldiers, as traditional camouflage methods are rendered ineffective. Thus, militaries must continue to advance existing thermal camouflage technologies to keep up with advanced detection methods.

In general, metallic materials are known to strongly reflect electromagnetic radiation due to the free electrons in the conduction band which may form a plasmonic resonance with incident photons to cause reflection. Existing technologies for low emissivity materials may incorporate nanoparticles that are suspended within a resin system. Commonly used nanoparticles include zinc oxide, ITO, gold, silica, and/or titanium dioxide. While useful for many applications, most of these existing solutions require extremely high loading concentrations to achieve tunable emissivity, which may destabilize the coating formulation and decrease performance and/or result in low optical quality due to nanoparticle agglomeration.

Additionally, IR technology within the textile industry applies embedded additives. These are colorants made of micro or nanoparticles that may be incorporated at various stages of the manufacturing process. Some examples are metallic oxide powders, carbon black and complex multi-metal compounds. Such technologies alter and impact the visual colour (and therefore visual camouflage) of these textiles. This may also limit the ability to tune or vary emissivity across a surface with these additives.

Accordingly, there is a need for improved multi-spectral low emissivity compositions and methods that overcome at least some of the disadvantages of existing solutions.

### SUMMARY

Provided is a low emissivity material comprising a low emissivity pigment, the pigment comprising a conductive nanomaterial and a resin. The pigment is dispersed into the resin, forming a matrix of conductive nanomaterial.

The pigment may include a metallic nanomaterial.

The pigment may include any one of a silver nanomaterial, copper nanomaterial, iron nanomaterial, aluminum nanomaterial or gold nanomaterial.

The pigment may include a conductive polymer nanomaterial.

The pigment may be a 1D nanomaterial.

The pigment may be a 2D nanomaterial.

The material may further include a solvent.

The material may further include a diffusing agent for scattering infrared radiation.

The material may further include a hardening agent.

Provided is a method of producing a low emissivity material comprising dispersing a low emissivity conductive nanomaterial pigment into a resin, producing the low emissivity material.

The method may further include mixing a solvent into the low emissivity material.

The method may further include forming the low emissivity material into a textile fiber.

Provided is a method of applying a low emissivity coating to a substrate, the method comprising coating a substrate with a low emissivity material comprising a resin and conductive nanomaterial low emissivity pigment.

The method may further include curing the low emissivity material after coating the substrate.

The method may further include exposing the low emissivity coating material to ultraviolet radiation.

The method may further include exposing the low emissivity coating material to an elevated temperature.

The substrate may be further coated with a liner or adhesive.

Applying the low emissivity material to the substrate may include spin coating the substrate with the material.

Applying the low emissivity material to the substrate may include pad coating the substrate with the material.

The substrate may be a textile.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is an illustration of two low emissivity materials, one comprising 1D pigments, and another comprising 2D pigments, according to an embodiment;

FIG. 2 is a table outlining the composition of a low emissivity material, according to an embodiment;

FIG. 3 is a chart detailing the emissivity versus nanomaterial loading of a low emissivity material, according to an embodiment;

FIG. 4 is a chart detailing the optical clarity versus nanomaterial loading of a low emissivity material, according to an embodiment;

FIG. 5 is a diagram illustrating a low emissivity material applied onto a substrate as a coating, according to an embodiment;

FIG. 6 is a table outlining the composition of a low emissivity material, according to an embodiment;

FIG. 7 is a table outlining the composition of a low emissivity material, according to an embodiment;

FIG. 8 is a diagram illustrating a low emissivity material applied onto a substrate as a coating, according to an embodiment;

FIG. 9 is a table outlining the composition of a low emissivity material, according to an embodiment;

FIG. 10 is a table outlining the composition of a low emissivity material, according to an embodiment;

FIG. 11 is a diagram illustrating a low emissivity material applied onto a substrate as a coating, according to an embodiment;

FIG. 12 is a table outlining the composition of a low emissivity material, according to an embodiment;

FIG. 13 is a table outlining the composition of a low emissivity material, according to an embodiment;

FIG. 14 is an illustration of a low emissivity material formed into a textile fiber, according to an embodiment;

FIG. 15 is a table outlining the composition of a low emissivity material for forming textile fibers, according to an embodiment;

FIG. 16 is a table outlining the composition of a low emissivity material for forming textile fibers, according to an embodiment;

FIG. 17 is a table outlining the composition of a low emissivity material, according to an embodiment;

FIG. 18 is a diagram illustrating a low emissivity material applied onto a self-adhering substrate as a coating, according to an embodiment;

FIG. 19 is a diagram illustrating a low emissivity material applied onto a textile substrate as a coating, according to an embodiment;

FIG. 20 is a table outlining the composition of a low emissivity material, according to an embodiment;

FIG. 21 is a table outlining the composition of a top layer material, according to an embodiment;

FIG. 22 is a flowchart of a method of manufacturing a low emissivity material, according to an embodiment;

FIG. 23 is a flowchart of a method of applying a low emissivity material as a coating, according to an embodiment;

FIGS. 24A, 24B, 24C, and 24D are images of diffuse reflectance, in accordance with an embodiment;

FIG. 25 is a graph showing the effect of layering low emissivity material on tuning or modifying the final emissivity of a fabric, and the corresponding impact on diffuse reflectance; and

FIGS. 26A and 26B are images of coated and uncoated fabric blocking IR thermal radiation from the body, in accordance with an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to materials, and more particularly, to materials including nano materials, such as 1D and 2D metallic nanomaterials, to produce low emissivity materials and/or coatings with stable and/or tunable emissivity characteristics and/or high optical clarity, and associated methods.

For the purpose of this disclosure, the conductive nano additives and the conductive mesh they form have been jointly termed “low E pigment” or “low emissivity pigment”.

For the purpose of this disclosure, “low emissivity material” refers to a material comprising low emissivity characteristics, provided for by the presence of low E pigments within a resin matrix. “low emissivity coating” refers to a low emissivity material particularly configured or formulated for the application of the material onto a substrate in a thin layer, forming a coating. A “low emissivity coating” may further include substances such as volatile solvents which may enable the coating to be applied, or may be identical in composition to a low emissivity material not configured for the application as a thin coating. The low emissivity coating may change in character after application and curing. For example, the low emissivity coating may chemically change, or may lack a volatile solvent after curing.

The composition and coating embodiments described herein comprise an ability to form a dense conductive mesh of 1D and/or 2D nanomaterials without significantly impacting an underlying surface's visual appearance. This conductive mesh, created with the use of conductive nanomaterials, such as ultrathin silver nanowires according to one embodiment, offers multispectral camouflage while not substantially altering the visual appearance of the coating and the underlying material or substrate. The conductive mesh interacts strongly with IR radiation, acting as a low pass filter (i.e, transparent to visible light and visible camouflage, but reflecting in the IR spectrum). The conductive mesh, comprising randomly oriented nanoparticles or materials in three dimensions, allows for a diffuse reflecting surface which in turn prevents detection from ambient IR sources.

The embodiments described herein comprise new and improved materials for application to low emissivity coatings, which comprise the conductive mesh described above to reflect short-wave infrared (SWIR) to mid-wave infrared (MWIR), and long-wave infrared (LWIR). These materials may be applied to IR stealth applications. The conductive mesh may be produced using one dimensional (1D) or two-dimensional (2D) nanomaterials dispersed in a resin to improve emissivity control within the coating. Also described herein is a method of manufacturing and applying such a coating from the materials described herein.

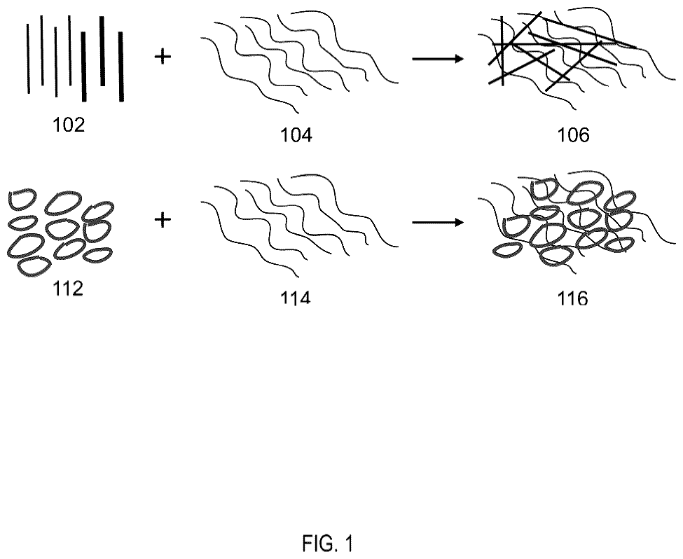

Referring first to FIG. 1, shown therein are generalized depictions of the materials 106, 116 described herein. Each material 106, 116 comprises a low emissivity pigment, dispersed or otherwise incorporated into a resin. Material 106 comprises a 1D low emissivity pigment 102, dispersed into a resin 104. Material 116 comprises a 2D low emissivity pigment 112, dispersed into a resin 114.

The low emissivity pigments (e.g. pigments 102, 112) described herein may comprise a wide variety of one dimensional (1D) conductive nanomaterials, two dimensional (2D) conductive nanomaterials or any combinations thereof. According to one embodiment, the 1D nanomaterials resemble nanowires. Alternatively, the 1D nanomaterials may also resemble nanorods, nanowhiskers or other 1D form factors. The 2D materials, according to one embodiment, resemble flakes. Alternatively, they may also resemble plates, flat grains, sheets or other form factors known to those skilled in the art.

The 1D or 2D low emissivity pigments may comprise a number of constituent elements. One embodiment comprises silver nanowires (AgNWs) while another embodiment comprises copper flakes. Alternative suitable low E pigment compositions include various form factors of gold, iron, aluminium, or other similar materials. The low E pigments may also comprise carbon-based materials such as a single carbon nanowire, carbon nanotube, carbon nanofiber, graphene or graphite or a combination of carbon nanowires, carbon nanotubes, carbon nanofibers, graphene or graphite. In other embodiments, the low E pigments may comprise conductive ceramic nanostructures. These conductive ceramic nanostructures may comprise metallic and non-metallic oxides, nitrides, and combinations thereof.

In some examples, the low emissivity pigment may comprise a mixture or combination of a metallic nanomaterial (e.g. silver wires) and a conductive polymer such as polyacetylene (PA) or polyaniline (PANI).

The 1D nanomaterials may comprise an approximate length in the range of 100 nm-100 μm and an approximate diameter in the range of 1-500 nm.

The 2D nanomaterials may comprise a specific area and a specific thickness. According to an embodiment, the 2D nanostructured materials may comprise an approximate area in the range of 100 nm2-1000 μm2 and an approximate thickness in the range of 1-500 nm.

In some examples, a composition may comprise a combination of both 1D and 2D nanomaterials. 1D and 2D are descriptors for nanomaterials,

The resin (e.g. resin 104 or 114) may comprise any resin which may support dispersion of the low E pigments described herein into the resin. The resin forms the bulk solid of the composition or material. The resin may comprise an acrylic-based resin selected for the properties of durability, mechanical strength, optional low surface energy, and reflective indices suitable for the desired application. According to some embodiments, the resin may comprise a polymer resin. According to some embodiments, the resin may comprise acrylate, alkoxysilane, acrylic urethane, polyurethane, trimethylolpropane triacrylate, silane, siloxane, epoxy, silicone, polyurea or similar. According to some embodiments, the resin may be UV or energy-curable. According to some embodiments, the resin may be cured thermally, under moisture exposure or any combination of curing methods previously mentioned. According to some embodiments, the resin comprises of a two-part resin system, wherein two substances are combined to form a resin, wherein the two parts may chemically interact to form the resin.

In some embodiments, the polymer resin may be optionally dissolved or dispersed in a solvent at a predetermined ratio. The solvent may enable the material to be applied to a substrate as a thin coating. In some examples, the resin and/or the pigment may each be dissolved or dispersed into a solvent before combing the resin and pigment. Examples of suitable solvents may include isopropyl alcohol, ethanol, acetone, water, or other similar solvents. Other solvents may include benzene, toluene, ethylbenzene, mixed xylenes (BTEX) and high flash aromatic naphthas, and acetates including ethyl acetate, and butyl acetate (n-butyl or iso-butyl).

According to some embodiments, the low emissivity materials may optionally comprise one or more diluting resin(s) or reactive diluents. The diluting resin or reactive diluent may function to improve the viscosity of a coating solution formed from these materials, while still maintaining a high degree of crosslinking with the bulk polymer resin. Examples of suitable reactive diluents include one or a combination of multifunctional acrylates such as 1,6-hexanediol acrylate (HDDA), tripropylene glycol diacrylate (TPGDA), or similar substances.

According to some embodiments, the low emissivity material may comprise a curing agent, an example of which is a photoinitiator, for initiating polymerization and curing the material. The photoinitiator may be selected for its high reactivity to UV light, low odor, and colour stability. According to one embodiment, the photoinitiator may be a combination of multiple oligomeric polyfunctional alpha-hydroxyketones such as oligo [2-hydroxy-2-methyl-1-[4-(1-methylvinyl)phenyl]propanone] and 2-hydroxy-2-methypropiophenone. Suitable photoinitiators may alternatively be one or more of Irgacure 184, Irgacure 500, Darocur 1173, Irgacure 2959 or Irgacure 127 or other substances.

According to some embodiments, the low emissivity material may comprise a flow and leveling agent for providing the cured film with superior coating quality. The flow and leveling additive may be one or more of polydimethylsiloxane (PDMS), fluorinated siloxane, fluorinated silane, fluoro-alkyl polymer, silicone, or polyhedral oligomeric silsesquioxanes or other substances.

According to some embodiments, the low emissivity material may further comprise additives which may produce other beneficial properties or improve properties of the coating. One such beneficial property is diffuse reflectivity. This is especially useful for stealth applications as IR radiation from ambient sources is diffused across the surface of the conductive mesh coating. One embodiment contains a wax-based matting agent to produce the property of diffuse reflectivity. Such additives may be referred to as diffusing agents.

According to some embodiments, the low emissivity materials may optionally contain UV stabilizers for improved weatherability of the coating when used in outdoor applications. The UV stabilizers may be one or a combination of UV inhibitors and UV absorbers, examples of which include hydroxyphenyl-triazine, Bis(1,2,2,6,6-pentamethyl-4-piperidyl) sebacate, and methyl 1,2,2,6,6-pentamethyl-4-piperidyl sebacate or other substances. The low emissivity materially may optionally comprise an oxygen scavenger for terminating free radicals in the solution. The oxygen scavenger may be carbohydrazide, diethylhydroxylamine or benzene-1,4-diol or other substances.

According to some embodiments, the low emissivity material may optionally comprise surface modification additives to provide the material, when cured, with hydrophobic and oleophobic properties. These surface modifiers may comprise one or more of polydimethylsiloxane (PDMS), fluorinated siloxane, fluorinated silane, fluoro-alkyl polymer, silicone, or polyhedral oligomeric silsesquioxanes.

The low emissivity materials of this disclosure may be produced by mixing a plurality of 1D and 2D conductive nanomaterial pigments with a resin. The process may involve mixing the conductive nanomaterial based low E pigments directly into the polymer resin. According to some embodiments, the nanomaterial pigments may be dried into a powder and mixed directly into the resin using high shear mixing through mechanical stirring, extrusion, or other methods. In other embodiments, the nanomaterial based low E pigments may be mixed into the resin by a solvent exchange using cross-flow filtration with any suitable solvent. Examples of suitable solvents include isopropyl alcohol, ethanol, acetone, water, or other similar solvents. Alternatively other mixing methods such as ultrasonic mixing/dispersion, mill-based homogenization, vortex shaking, among others can be applied.

In some examples, the nanomaterial pigments may be mixed into the resin following a functionalization process. The functionalization process may use known organic chemistry methods to install functional groups onto the surface of the nanostructured pigment material. The functionalization may improve the affinity of the nanostructured material for the polymer resin which may improve dispersion of the nanostructured material within the polymer resin. Improved dispersion within the polymer resin may improve the optical quality of the coating by reducing haze that can result from aggregation of the nanostructures. According to an embodiment, the functionalization process adds acrylic functional groups to the surface of the nanomaterials comprising the low E pigment. Alternatively, the functionalization process may add other chemical groups to increase dispersion or cross-linking with the polymer resin. A silane linker or thiol may be applied to covalently bond functional groups to the nanomaterial-based pigments.

These processes for mixing the nanomaterial pigments and the polymer resin results in the formation of a conductive nanomaterial based low emissivity material.

Once produced, the materials described herein may be applied to a substrate as a coating. Substrates may comprise semi-rigid or rigid materials such as glass, polycarbonate (PC), poly(methyl methacrylate) (PMMA), polyether ether ketone (PEEK), polyimide, epoxy, polystyrene, nylon, polyethylene, polypropylene, polyurethane, polyethylene terephthalate (PET), glycol-modified PET, or polyethylene naphthalate (PEN). The substrate may also comprise flexible and/or stretchable substrates including but not limited to textiles, fabrics, polymer films, membranes and other such substrates. For a fabricated coated surface, the low emissivity coating layer may be deposited directly onto the substrate.

The materials described herein may be applied directly onto a substrate through a process such as pad coating, rod coating, or roll coating, or indirectly as a secondary film on a substrate to bring about the desired emissivity properties. Other coating methods, may include immersion coating, transfer coating, heat lamination, adhesive lamination.

Alternatively, the low emissivity materials described herein may be incorporated in textiles and other material composites at any stage of the manufacturing processes of such materials instead of applying the low emissivity materials to a textile substrate.

The low emissivity material may be cured by exposure to UV radiation, after the application of the material to a substrate or otherwise. UV-cured coatings may include the addition of a photoinitiator to initiate the polymerization of the resin.

In other examples, the low emissivity material may be cured through other processes, such as exposure to elevated temperatures, moisture, or visible light radiation.

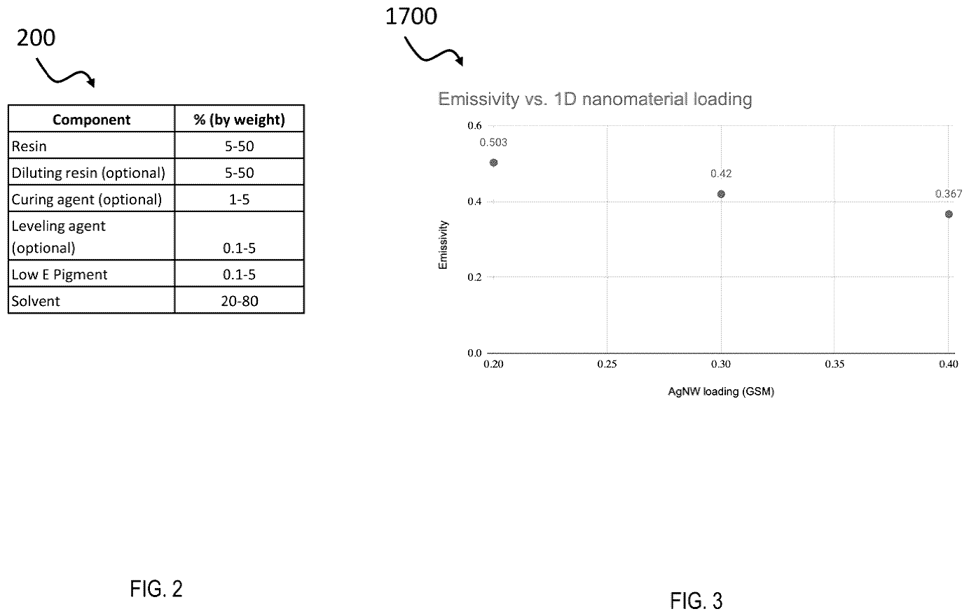

Referring now to FIG. 2, shown therein is a table 200, outlining the range of compositions of low emissivity materials described herein, according to an embodiment. As outlined in table 200, the material may comprise a resin, low E pigment, solvent, and optionally, a diluting resin, curing agent, and/or a leveling agent. In some embodiments, the coatings may comprise the following component ratios or amounts by weight: resin 5-50%, low E pigment 0.1-5%, solvent 20-80%, diluting resin 5-50%, curing agent 1-5%, and leveling agent 0.1-5%. In other embodiments, additional components may be included in the material, and the amounts or ratios may differ from those described above.

Referring now to FIG. 3, shown therein is a chart 1700 depicting the variation of emissivity of the low emissivity material against the concentration of the disclosed low emissivity pigment. Chart 1700 depicts that an increase in the concentration of the specific low E pigment (AgNWs), there is a decrease in the emissivity of the measured specimen. Lower concentrations or loadings of low E pigment may decrease the emissivity of a surface.

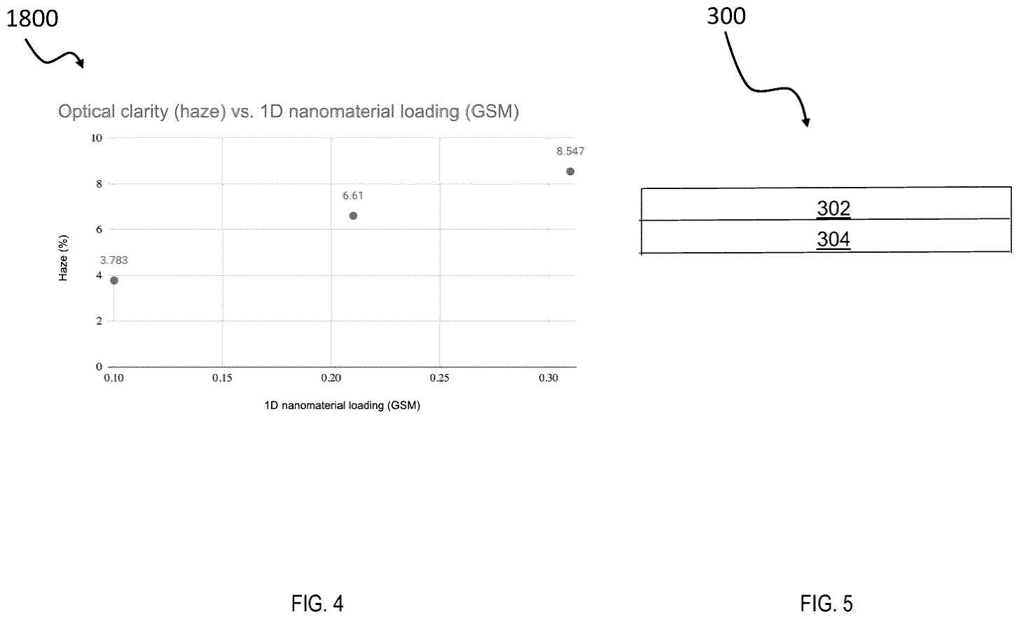

Referring now to FIG. 4, shown therein is a chart 1800, depicting the variation of a substrate's optical quality (measured as % haze) against various concentrations of the 1D low emissivity pigment within a low emissivity material applied to the substrate. The addition of these conductive nanomaterials at these loadings does not drastically change the coatings' haze, indicating that superior optical quality may be achieved while maintaining control of emissivity parameters which is not achievable with alternative low emissivity compositions.

The materials described herein may be applied to any substrate to provide the substrate with low emissivity properties, while remaining optically clear, such that the substrate is visually similar after application of the low emissivity material as before the application of the low emissivity material. For example, when applied to a substrate with a visual camouflage pattern, the camouflage pattern may be substantially visible through the low emissivity coating.

The materials described herein may be applied to Touch displays, Antibacterial coatings on rigid surfaces and textiles, Construction, solar control film generally. Anti-frost film, water rejection applications, and automotive applications such as solar control films for vehicle windshields and automotive anti-frost films.

### Example Embodiment A

Referring now to FIG. 5, shown therein is a material 300 comprising a substrate 304 coated with a low emissivity coating 302, according to an embodiment. Embodiment A is not limited to any particular material or geometry. Coating 302 is a low emissivity coating that is manufactured by the inclusion of metallic (for example, silver) nanowires. This coating is intended to be directly applied onto a substrate 304.

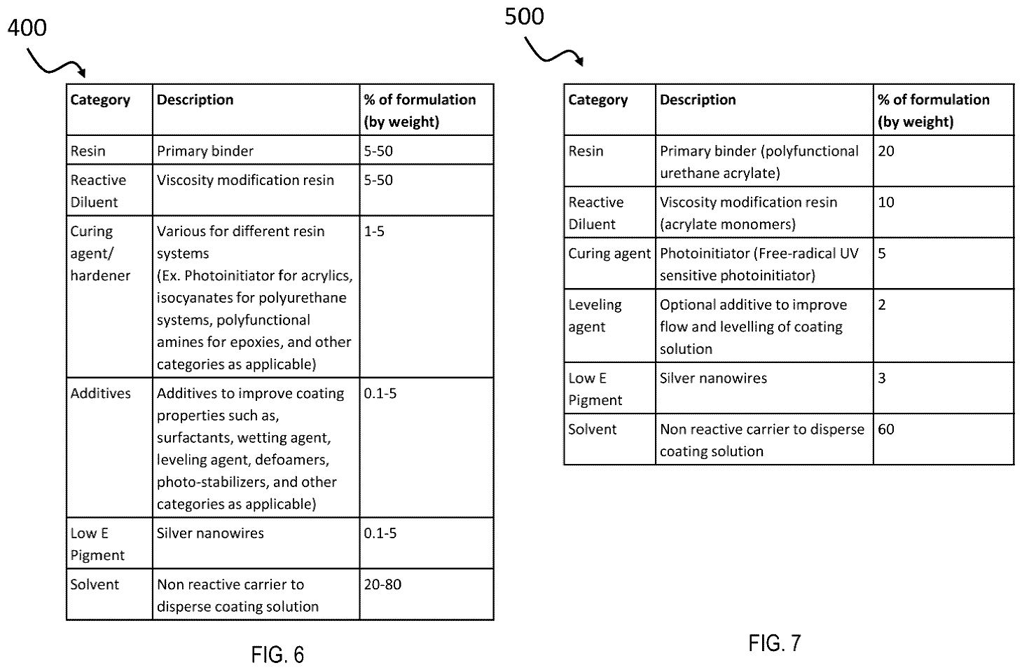

Referring now to FIG. 6, shown therein is a table 400 detailing the composition of the coating 302 of Embodiment A, as shown in FIG. 3. Table 400 describes a coating material comprising silver nanowires as the low emissivity pigment. The categories described in table 400 refer to the ranges of various components that comprise the coating solution defined within Embodiment A.

Referring now to FIG. 7, pictured therein is table 500, which details a specific example of the composition of a coating of Embodiment A, such as coating 302. Coating 302 comprises a polyfunctional urethane acrylate resin, an acrylate monomer reactive diluent which functions as a viscosity modification resin, a free-radical UV sensitive photo initiator which functions as a curing agent, a levelling agent, silver nanowires which function as the low E pigment, and a solvent comprising a non-reactive carrier which allows the coating 302 to be dispersed, e.g. onto substrate 304. The relative proportions of each component of the coating 302 is detailed in table 500, in weight percentage.

In the example of Embodiment A detailed in table 500, a high-functionality aliphatic urethane acrylate such as Ebecryl 5128 from Allnex GmbH may be used as the primary binder. Other options for similar resins are Photomer 6631 from IGM Resins, CN9006 from Sartomer/Arkema Americas, Ebecryl 1290 from Allnex GmbH, Aliphatic Urethane Acrylate 7610 from Jiangmen Heng Guang New Material, SUO 1700 from Polygon Chemie, Laromer UA9030 from BASF, BYD 6006 from Tianyi Chemical Engineering Material, Olester RA 1500 by Mitsui Chemicals, or Aliphatic Polyurethane-Acrylic B910A4 from Guangzhou Bossin Chemical Technology or other such products. Darocur 1173 from BASF was used as the curing agent. Other options for similar photoinitiators are Darocur 4625 by BASF, Firstcure HCPK by Albemarle, Chivacure 300 by Chitec Technology, PI-184 by Dalian Richfortune Chemicals, Varnifm Photoinitiator 184 by Fenchem, Flecure 1173 by First Light Enterprises, Omnirad 184 by IGM Resins, or Benacure 1173 by Mayzo or other such products.

In the example of Embodiment A detailed in table 500, the silver nanowires were obtained pre-dispersed in IPA (20 mg/mL) from ACS Material LLC. Other supplier options include but are not limited to Alfa Chemistry, Nanochemazone, Novarials Corporation, nanoComposix Inc, NanoTechLabs Inc, PlasmaChem GmbH, Sisco Research Laboratories Pvt. Ltd. Hongwu International Group, American Elements, Nanorbital, and NanoShel, etc.

The final coating 302 was produced by mixing high-functional urethane acrylate, multifunctional acrylate TPGDA (reactive diluent solvent, Tri (propylene glycol) diacrylate from Sigma Aldrich), a photoinitiator (Darocur 1173 from BASF), low emissivity pigment, and flow and leveling agent Borchi Gol 0011 by Borchers. Other flow and leveling agents may include, but are not limited to, Thetawet FS-8250 by Innovative Chemical Technologies, Tivida FL 2300 by Merck KgaA Darmstadt Germany, Siltech C-101 by Siltech, Polyfox PF-151N by Synthomer, Additol VXL 4930 by Allnex or other such products.

The low emissivity composition detailed in table 500 was rod-coated on a rigid substrate (e.g., substrate 304), dried at elevated temperature to evaporate the solvent, and cured under a metal-halide lamp for photopolymerization. The low emissivity composition may be applied to any substrate using any known method of coating. Suitable coating methods include rod coating, doctor blade coating, spin coating, spray coating, dip coating, comma coating, brush coating, dip coating, roll coating, or any other suitable coating method.

The coatings of Embodiment A may be used on rigid substrates including, but not limited to polycarbonate (PC), poly(methyl methacrylate) (PMMA), polyether ether ketone (PEEK), polyimide, epoxy, polystyrene, nylon, polyethylene, polypropylene, polyurethane, polyethylene terephthalate (PET), glycol-modified PET, polyethylene naphthalate (PEN) or glass. The coating of embodiment A is particularly suited for vehicle body applications. It may also be used for stealth shelters, shield walls or other similar or analogous applications.

### Example Embodiment B

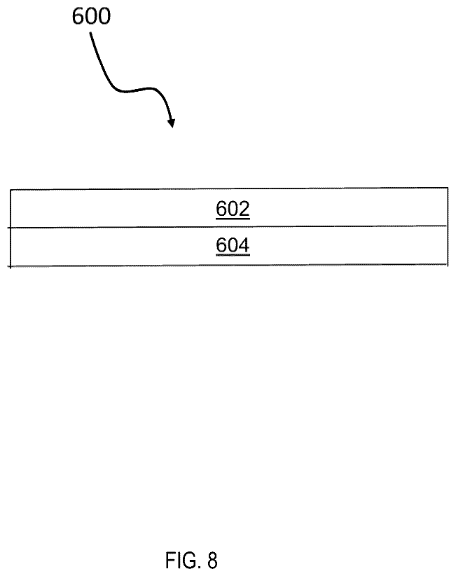

Referring now to FIG. 8, shown therein is a material 600 comprising a substrate 604 coated with a low emissivity coating 602, according to an embodiment. Embodiment B is not limited to any particular material or geometry. Coating 602 is a low emissivity coating that is manufactured by the inclusion of metallic copper nanowires. This coating 602 is intended to be directly applied onto a substrate 604 of any type. Coating 602 comprises diffuse reflectance that masks thermal signatures in the long-wave IR spectral range and prevents detection from strong ambient IR sources. The specifications of long-wave IR spectral range may include a 8-14 um wavelength range.

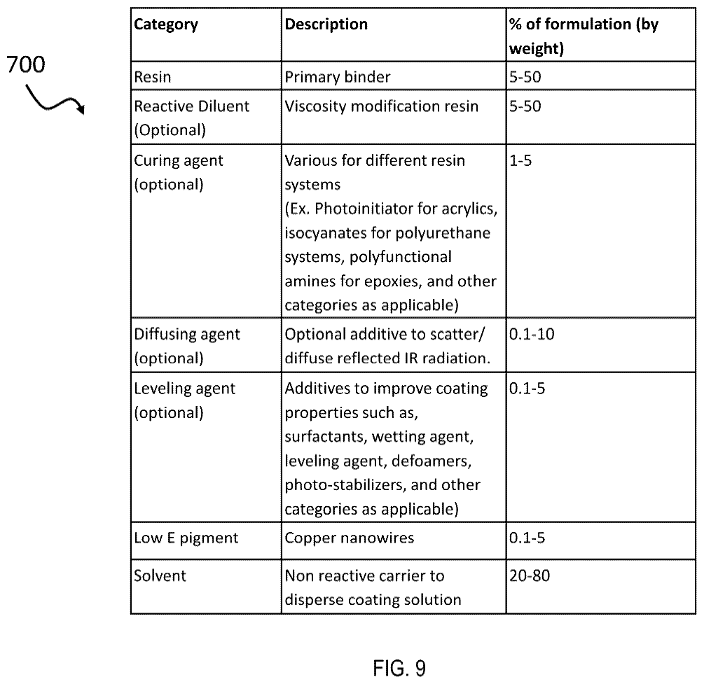

Referring now to FIG. 9, shown therein is a table 700 detailing the range of compositions of the coating 602 of Embodiment B, as shown in FIG. 8. Table 700 describes a coating material comprising copper nanowires as the low emissivity pigment as well as a specialized additive to diffuse any incident IR radiation from ambient sources. The categories described in table 700 refer to the ranges of various components that comprise the coating solution defined within Embodiment B. The proportions listed in table 700 comprise weight percentages.

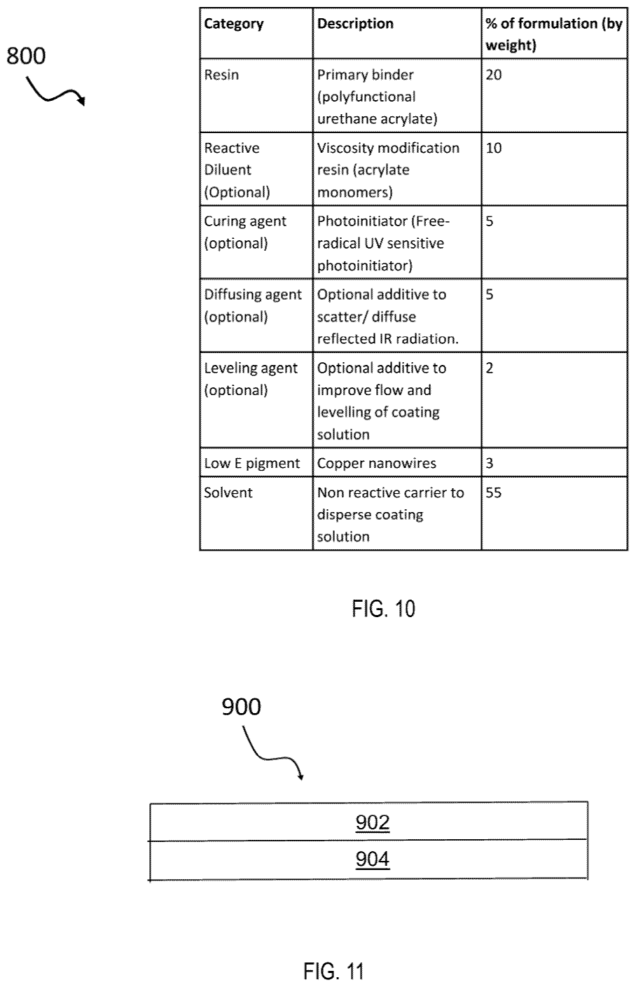

Referring now to FIG. 10, pictured therein is table 800, which details a specific example of the composition of a coating of Embodiment B, such as coating 602. Coating 602 comprises a polyfunctional urethane acrylate resin, an acrylate monomer reactive diluent which functions as a viscosity modification resin, a free-radical UV sensitive photo initiator which functions as a curing agent, a diffusing agent, which comprises an additive configured to scatter and/or diffuse reflected IR radiation, a levelling agent, copper nanowires which function as the low E pigment, and a solvent comprising a non-reactive carrier which allows the coating 602 to be dispersed, e.g. onto substrate 604. The proportions listed in table 800 comprise weight percentages.

A high-functionality aliphatic urethane acrylate such as Ebecryl 5128 from Allnex GmbH was used as the primary binder. Other options for similar resins are Photomer 6631 from IGM Resins, CN9006 from Sartomer/Arkema Americas, Ebecryl 1290 from Allnex GmbH, Aliphatic Urethane Acrylate 7610 from Jiangmen Heng Guang New Material, SUO 1700 from Polygon Chemie, Laromer UA9030 from BASF, BYD 6006 from Tianyi Chemical Engineering Material, Olester RA 1500 by Mitsui Chemicals, or Aliphatic Polyurethane-Acrylic B910A4 from Guangzhou Bossin Chemical Technology or other such products known to those skilled in the art. Darocur 1173 from BASF was used as the curing agent. Other options for similar photoinitiators are Darocur 4625 by BASF, Firstcure HCPK by Albemarle, Chivacure 300 by Chitec Technology, PI-184 by Dalian Richfortune Chemicals, Varnifm Photoinitiator 184 by Fenchem, Flecure 1173 by First Light Enterprises, Omnirad 184 by IGM Resins, or Benacure 1173 by Mayzo or other such products known to those skilled in the art.

The copper nanowires were obtained pre-dispersed in IPA (20 mg/mL) from ACS Material LLC. Other options include but are not limited to Alfa Chemistry, Nanochemazone, Novarials Corporation, nanoComposix Inc, NanoTechLabs Inc, PlasmaChem GmbH, Sisco Research Laboratories Pvt. Ltd. Hongwu International Group, American Elements, Nanorbital, and NanoShel, etc. An optional diffusing agent Gasoloid Matting Agent B205 by Tianyi Chemical Engineering Material was added to create a matte effect and thereby diffuse reflected IR radiation. Similar additives, including but not limited to Ebecryl 898 by Allnex, Masterwax Matting by Deurex, Gasil HP560 by PQ Corporation, ACEMATT TS 100 by Evonik, and Calcium Stearate by Dongguan CHNV Technology, and other products known to those skilled in the art.

The final coating was made by mixing high-functional urethane acrylate, multifunctional acrylate TPGDA (reactive diluent solvent, Tri (propylene glycol) diacrylate from Sigma Aldrich), a photoinitiator (Darocur 1173 from BASF), low emissivity pigment, diffusing additive, and flow and leveling agent Borchi Gol 0011 by Borchers. Other flow and leveling agents can include but are not limited to Thetawet FS-8250 by Innovative Chemical Technologies, Tivida FL 2300 by Merck KgaA Darmstadt Germany, Siltech C-101 by Siltech, Polyfox PF-151N by Synthomer, Additol VXL 4930 by Allnex or other such products known to those skilled in the art.

The resin mixture above was rod-coated on a rigid substrate, dried at elevated temperature to evaporate the solvent, and cured under a metal-halide lamp for photopolymerization. The coating solution may be applied to any substrate using any known method of coating. Suitable coating methods include rod coating, doctor blade coating, spin coating, spray coating, dip coating, comma coating, brush coating, dip coating, roll coating, or any other coating method known to those in the art.

This coating can be used on rigid substrates including, but not limited to polycarbonate (PC), poly(methyl methacrylate) (PMMA), polyether ether ketone (PEEK), polyimide, epoxy, polystyrene, nylon, polyethylene, polypropylene, polyurethane, polyethylene terephthalate (PET), glycol-modified PET, polyethylene naphthalate (PEN) or glass. This embodiment is particularly suitable for vehicle body applications. It can also be used for stealth shelters, shield walls or other similar applications.

The inclusion of the diffusing additives gives the coating solution described within this embodiment the unique ability to evade detection from both active and passive infrared sensors. By diffusing incident ambient IR radiation, this additive ensures a strong IR radiation source (e.g. the sun) does not reflect off the low-e surface and form a beacon to the observer.

### Example Embodiment C

Referring now to FIG. 11, shown therein is a material 900 comprising a substrate 904 coated with a low emissivity coating 902, according to an embodiment. Embodiment C is not limited to any particular material or geometry. Coating 902 is a low emissivity coating that is manufactured by the inclusion of metallic (primarily copper) nano flakes. This coating 902 comprises a two-part composition, which is to be combined before application. This coating 902 is intended to be directly applied onto a substrate 904, of any type.

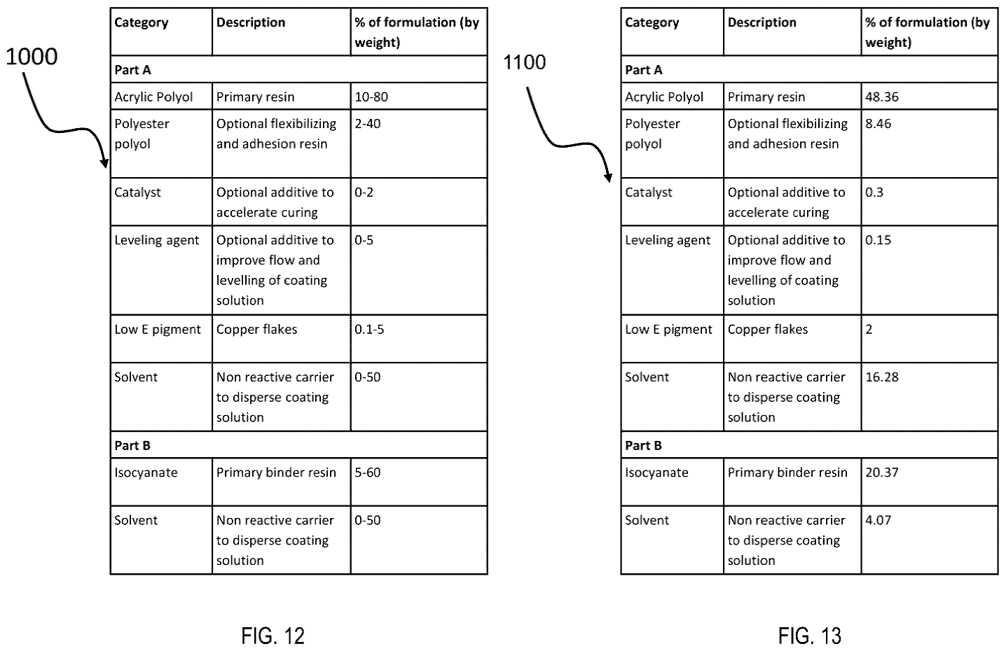

Referring now to FIG. 12, shown therein is a table 1000 detailing the composition of the coating 902 of Embodiment C, as shown in FIG. 9. Table 1000 describes a thermally cured, flexible low emissivity coating comprising a conductive mesh on flexible substrates, primarily textiles. In this embodiment, the conductive mesh is created by using 2D metallic nanoparticles. Coating 902 comprises a two-component polyurethane coating configured for use on textiles and other flexible substrates. The categories described in table 1000 describe the weight percentage ranges of various components that comprise the coating solution defined within Embodiment C.

Referring now to FIG. 13, pictured therein is table 1100, which details a specific example of the two-part composition of the coating of Embodiment C, such as coating 902. Coating 902 comprises Part A, including acrylic polyol resin, polyester polyol resin, a catalyst, leveling agent, low E pigment (copper flakes) and a solvent. Part A of coating 902 comprises an isocyanate resin and a solvent. The ratios of these listed components are outlined as weight percentages in table 1100.

An acrylic polyol, such as Joncryl 906 AC is the primary resin of the coating and included within Part A. Other high equivalent weight polyols, including but not limited to products such as Setalux 17-1215 by Allnex GmbH, PARALOID AU-608 TBZ Acrylic Polyol by Dow, AA-857 by Aekyung Chemical, DAILIC AC-5030 by Daily Polymer, POLYPOL 676 by Polychem Resins, U-1906AD-5 by Add & Poly Resin Industrial, or Disvacryl-1019 by D.S.V. Chemicals, etc, and other products. A flexibilizing polyester polyol resin, K-Flex XM-332 by King Industries is also added to Part A. Other similar polyols, including but not limited to products such as SETAL 1406 by Allnex GmbH, YA-2520 by Coating P. Materials, CR1120 by Poliser PU (Flokser Group), NGPS-2524 by Zhangjiang Nanguang Chemical, Urethhall 4050D-110 by Hallstar, or Hoopol F-10670 by Synthesia and other products.

An optional catalyst-K-KAT 4205 was added to boost the formulation's curing time. It is a zirconium chelate complex that is an effective catalyst for high solids 2-component urethane coatings. It is particularly effective for ambient and low temperature cure systems. Other products including but not limited to FOMREZ® UL-29 catalyst by Galata Chemicals (Artek), TIB KAT® 718 by TIB Chemicals (Goldschmidt TIB), Reaxis™ C216 by Reaxis, Dabco® NE1070 by Evonik, AHA 6314 by A.H.A, VALIKAT Bi 2808 by Umicore, TYTAN™ CA-Z222 by Borica, Tyzor® NPT by Dorf Ketal, and other products known to those skilled in the art. Optionally, flow and leveling agent BYK 310 by BYK Chemicals was added to enhance coating quality. Other flow and leveling agents can include but are not limited to Borchi Gol 0011 by Borchers, Thetawet FS-8250 by Innovative Chemical Technologies, Tivida FL 2300 by Merck KgaA Darmstadt Germany, Siltech C-101 by Siltech, Polyfox PF-151N by Synthomer, Additol VXL 4930 by Allnex or other such products.

The copper flakes were obtained in powder form from Belmont Metals. Other options include but are not limited to various other conductive flakes and other products by Alfa Chemistry, Nanochemazone, Novarials Corporation, nanoComposix Inc, NanoTechLabs Inc, PlasmaChem GmbH, Sisco Research Laboratories Pvt. Ltd. Hongwu International Group, American Elements, Nanorbital, and NanoShel, etc.

The primary component of Part B (which in 2K polyurethane coatings is often referred to as the binder or cross-linker), is an aliphatic polyisocyanate of HDI trimer type called Desmodur N-3300. Other products can include but are not limited to: Basonat HA 1000 by BASF, Desmodur BL 1100 (blocked polyisocyanate) by Covestro, Supresec 2018 by Huntsman, Quasilan CT 23 by Lanxess, POLURGREEN PRP 350 01 by Sapici, Tolonate™ IDT 70 B by Vencorex.

Parts A and B may be combined once formulated to form the low emissivity material for coating.

The low emissivity material (e.g. after combining Part A and B) above was rod-coated on a nylon textile, dried and cured at elevated temperature. The coating solution may be applied to any substrate using any known method of coating. Suitable coating methods include calendar coating, direct coating, foamed and crushed foam coating, transfer coating, rotary screen coating, rod coating, doctor blade coating, spin coating, spray coating, dip coating, comma coating, brush coating, roll coating, or any other coating method known to those in the art.

This embodiment is particularly suited, but not limited to for use on military textiles, including but not limited to ponchos, tents, tarps, uniforms, backpacks and utility belts, personal protective equipment (PPE), cords, ropes, cables, straps, and sheaths for carrying weapons, helmet coverings, flags, hats, gloves and belts, etc.

### Example Embodiment D

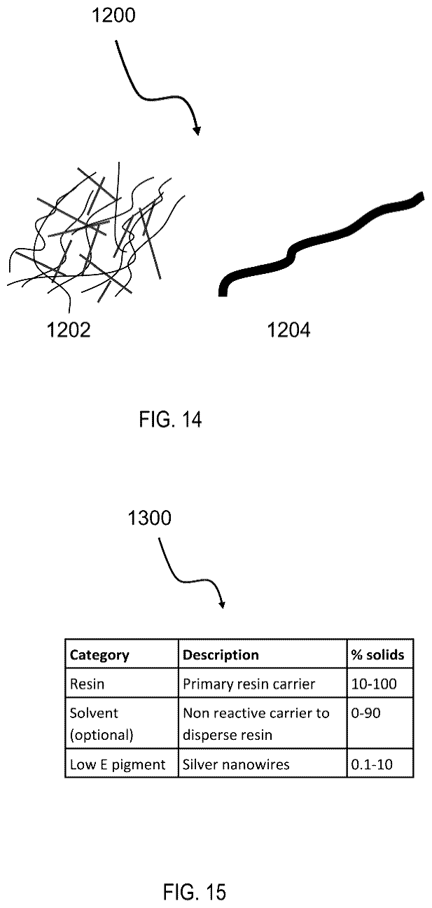

Referring now to FIG. 14, pictured therein is Embodiment D of a low emissivity material 1200. Visible in FIG. 14 is the material in bulk form 1202, as well as the bulk form 1202 formed into a fiber 1204. Fiber 1204 comprises a resin matrix, embedded with a low E pigment.

Referring now to FIG. 15, shown therein is a table 1300 detailing the range of compositions of the material 1200 of Embodiment D, as shown in FIG. 14. Table 1300 describes the composition of a dispersion of low E pigments in resin that is then extruded or processed in any other known way to form fibers for the production of textiles and fabrics. The categories listed in table 1300 refer to the various components that make up the resin-pigment dispersion (e.g. bulk form 1202) of material 1200 prior to forming fibers 1204, in weight ratio format.

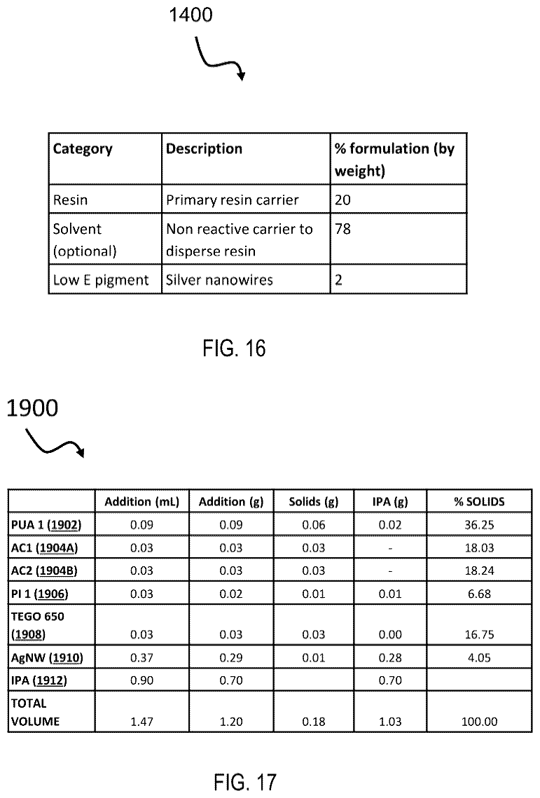

Referring now to FIG. 16, shown therein is a table 1400 detailing the specifications of a particular composition of Embodiment D, according to an embodiment.

The primary resin used was polyurethane powder/granules, such as PU granules from Avention of a particular weight percent. Other resin powders include but are not limited to acrylic, rayon, aramid, modacrylic, spandex and other materials known to those skilled in the art. With the appropriate selection of solvent, other polymer matrices can be used. Some examples of these are: cellulose, gelatin, polyethylene, polyacrylonitrile. Melt spinning can also be employed, which uses polymers such as nylon, olefins, polyester, saran, and other materials known to those skilled in the art.

The silver nanowires were obtained pre-dispersed in IPA (20 mg/mL) from ACS Material LLC. Other options include but are not limited to various conductive metal nanowires produced or supplied by Alfa Chemistry, Nanochemazone, Novarials Corporation, nanoComposix Inc, NanoTechLabs Inc, PlasmaChem GmbH, Sisco Research Laboratories Pvt. Ltd. Hongwu International Group, American Elements, Nanorbital, and NanoShell, etc.

Embodiment D is particularly suitable for the fabrication of IR camouflage and stealth capable fibers of various materials. The resulting fibers may be used to produce yarn and subsequently textiles and fabrics. The textiles and fabrics may in turn be used in a variety of finished products such as uniforms, tarps, tents, backpacks and utility belts, personal protective equipment (PPE), cords, ropes, cables, straps, and sheaths for carrying weapons, helmet coverings, flags, hats, gloves and belts, and any other suitable products.

### Example Embodiments E

Referring now to FIG. 17, shown therein is a table 1900 depicting the composition of a low E material, according to an embodiment. The material of embodiment E may be particularly suitable for deposition onto a substrate. The material of embodiment E comprises a polymer resin 1902 which forms the bulk solid in the cured coating film. The polymer resin 1902 may be an acrylic-based resin selected for the properties of durability, mechanical strength, optional low surface energy, and reflective indices suitable for the desired application. The polymer resin 1902 may be one or more of acrylate, alkoxysilane, acrylic urethane, polyurethane, trimethylolpropane triacrylate, silane, siloxane, epoxy, silicone, polyurea or similar. The polymer resin is dissolved in the solvent 1912 to approximately 10-20% of the total solids in the abrasion-resistant low emissivity material of Embodiment E. The low emissivity material of Embodiment E also optionally contains small reactive polymer resin groups 1904A and 1904B. The reactive diluent may function to improve the viscosity of the coating solution, while still maintaining a high degree of crosslinking with the bulk polymer resin. Examples of suitable reactive diluents include one or a combination of multifunctional acrylates such as 1,6-hexanediol acrylate (HDDA), tripropylene glycol diacrylate (TPGDA), or similar.

The low emissivity material includes 1D conductive nanomaterials 1910 which provide low emissivity through superior conductivity and form factor which enables the creation of a three-dimensional conductive mesh within the cured coating film. The 1D nanomaterials may be incorporated directly into the low emissivity material without any further modification. Alternatively, the 1D nanomaterials may be further modified with functional groups so as to improve dispersion of the 1D nanomaterials within the polymer resin. In the case of an acrylate-based polymer resin, the functional groups may be acrylic. The functional group may optionally be covalently bound to the 1D nanomaterials via a silane linker. Alternatively, the covalent linker may be a thiol.

The low emissivity material of Embodiment E includes a photoinitiator 1906 for initiating polymerization and curing the film. The photoinitiator 1906 is selected for its high reactivity to UV light, low odor, and colour stability. According to one embodiment, the photoinitiator may be a combination of multiple oligomeric polyfunctional alpha-hydroxyketones such as oligo [2-hydroxy-2-methyl-1-[4-(1-methylvinyl)phenyl]propanone] and 2-hydroxy-2-methypropiophenone. Suitable photoinitiators may alternatively be one or more of Irgacure 184, Irgacure 500, Darocur 1173, Irgacure 2959 or Irgacure 127. The photoinitiator 1906 is dissolved in the combined solvent 1912 to ˜2-10% of the total solids in the solution.

The low emissivity material of Embodiment E contains an optional flow and leveling agent 1908 for providing the cured film with superior coating quality. The flow and leveling additive 1908 may be one or more of polydimethylsiloxane (PDMS), fluorinated siloxane, fluorinated silane, fluoro-alkyl polymer, silicone, or polyhedral oligomeric silsesquioxanes.

The solid components are prepared in their respective solvents, then combined in the following order: 1902, 1904A, 1904B, 1906, 1908, 1910, and 1912. In other embodiments, other orders may be applied.

The low emissivity material of Embodiment E may be applied to any substrate using any known method of coating. Suitable coating methods include rod coating, doctor blade coating, spin coating, spray coating, dip coating, comma coating, brush coating, dip coating, roll coating, or any other coating method known to those in the art. The low emissivity coating may be cured by exposure to radiation.

According to one embodiment, the low emissivity coating of Embodiment E is cured by exposure to ultraviolet radiation. The low emissivity coating may alternatively be cured by a thermal curing method or in the presence of moisture.

### Example Embodiment F

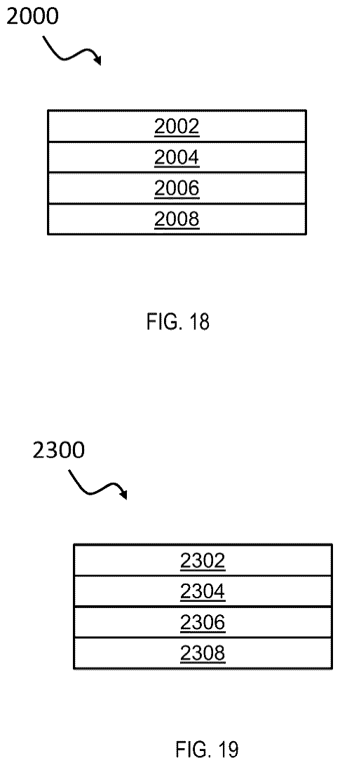

Referring now to FIG. 18, pictured therein is a is a multi-layer laminate film 2000, according to an embodiment. The multi-layer laminate film 2000 comprises a low emissivity coating layer 2002, a flexible substrate 2004, a pressure sensitive adhesive (PSA) 2006, and a release liner 2008. In other examples of film 2000, different adhesive types, and substrates may be applied. In other examples of film 2000, release liner 2008 may not be present.

In some examples, substrate 2004 may comprise film materials such as, without limitation, polyethylene, polypropylene, polyester, nylon, polyurethane, polyvinyl chloride, cellulose acetate, cellophane. In some examples, substrate 2004 may comprise combinations of these materials and related laminated arrangements. Substrate 2004 may comprise any polymer sheet or film substrate that may be shrunk onto vehicles or any other rigid surface.

The multi-layer laminate film 2000 may be used to apply low emissivity functionality to other surfaces or finished products as desired. For example, the release liner 2008 may be removed, exposing the PSA 2006. The film 2000 may then be applied to another substrate or material by attaching the film 2000 to another substrate of material with the PSA 2006, to provide this material or substrate with low emissivity properties. For example, film 2000 may be applied to a vehicle to provide the vehicle with low emissivity properties.

### Embodiment G

Described herein is an embodiment of a UV cured low E composition for application as a substrate coating. To produce the composition, a hexa-functional aliphatic urethane acrylate, namely Ebecryl 5129 from Allnex, is first mixed with IPA in a 3:1 ratio. The photoinitiator, Irgacure 184 from Sigma Aldrich was then mixed with IPA in a 1:1 ratio. The silver nanowires (Silver Nanowires from Cheap Tubes) were obtained pre-dispersed in IPA (20 mg/mL). The final coating is produced by mixing hexa-functional urethane acrylate, multifunctional acrylate TPGDA (reactive diluent solvent, Tri (propylene glycol) diacrylate from Sigma Aldrich) and HDDA (reactive diluent solvent, hexanediol diacrylate from Sigma Aldrich), a photoinitiator (Irgacure 184 from Sigma Aldrich), silver nanowires (Silver Nanowires From Chap Tubes), and flow and leveling agent (TEGO 650 from Evonik). In this embodiment, the above components are mixed in a ratio of 33:18:18:7:18:6 by raw component weight respectively. The resin mixture above may them be rod-coated on a PET substrate, dried at elevated temperature to evaporate the solvent, and cured under a metal-halide lamp for photopolymerization.

The result of Embodiment G is a PET substrate, coated with a silver nanowire based low emissivity coating.

### Embodiment H

Referring now to FIG. 19, shown therein is a depiction of a multi-spectral camouflage textile 2300, according to an embodiment. The textile 2300 comprises a substrate 2308, visual camouflage pattern and NIR camouflage pigments layer 2306, a low emissivity material layer 2304 and a top layer 2302. The top layer 2302 may be a protective layer. The top layer 3202 may have protective and/or other functional properties such as better hand-feel, hydrophobicity, adhesion for another layer to be laminated on top, etc.

The conductive mesh based low emissivity material of Embodiment H may be applied on a military uniform containing visual camouflage patterns and NIR pigments. The conductive mesh layer is applied on military uniform material along with top layer that performs any of the following functions, or combinations of functions: improving durability and reducing wear and tear of the conductive mesh layer, modifying hand and other qualitative aspects of the fabric, modifying the surface energy, slip or hydrophobicity of the low emissivity material and therefore the fabric, or serving as a layer on top of which other layers may be added (current thought is as an adhesive layer for the lamination of other layers, sort of in a peel-away application).

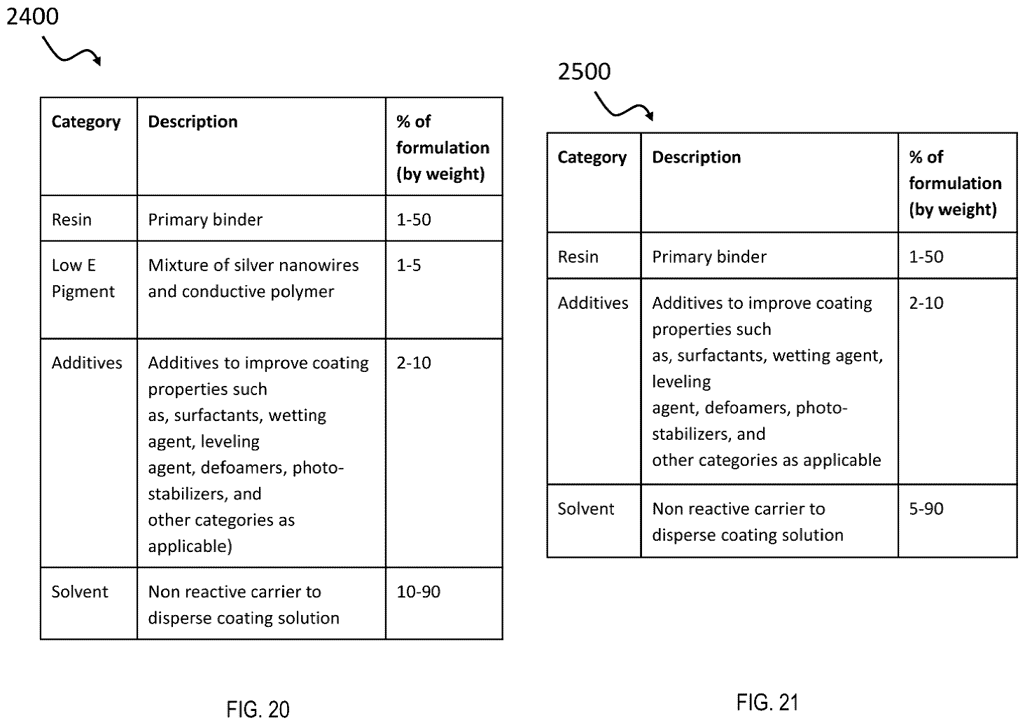

Referring now to FIG. 20, shown therein is a table 2400 detailing the composition range of low emissivity material layer 2304 of textile 2300. low emissivity material layer 2304 comprises a resin, low E pigment, additives and a solvent, proportions of which are outlined in table 2400 as weight percentage ranges.

Referring now to FIG. 21, shown therein is a table 2500 detailing the composition range of top layer 2302 of textile 2300. Top layer 2302 comprises a resin, additives and a solvent, proportions of which are outlined in table 2500 as weight percentage ranges.

In the textile 2300 of Embodiment H, the low emissivity material 2302 was coated on a substrate 2308 and visual camouflage pattern and NIR camouflage pigments layer 2306 combination (camouflage military fabric) through a pad coating process in which the textile substrate (combination of 2306 and 2308) is dipped in a trough of low emissivity material 2303 and then squeezed between two non-reactive rollers to remove excess low emissivity material 2302. The resultant textile 2300 is then cured in an oven to evaporate the solvent within the low emissivity material 2302 and cure and/or crosslink the resin. This process may be repeated to achieve the emissivity diffuse reflectance required. This process is repeated for a final time to apply the top layer 2302 as detailed in table 2500.

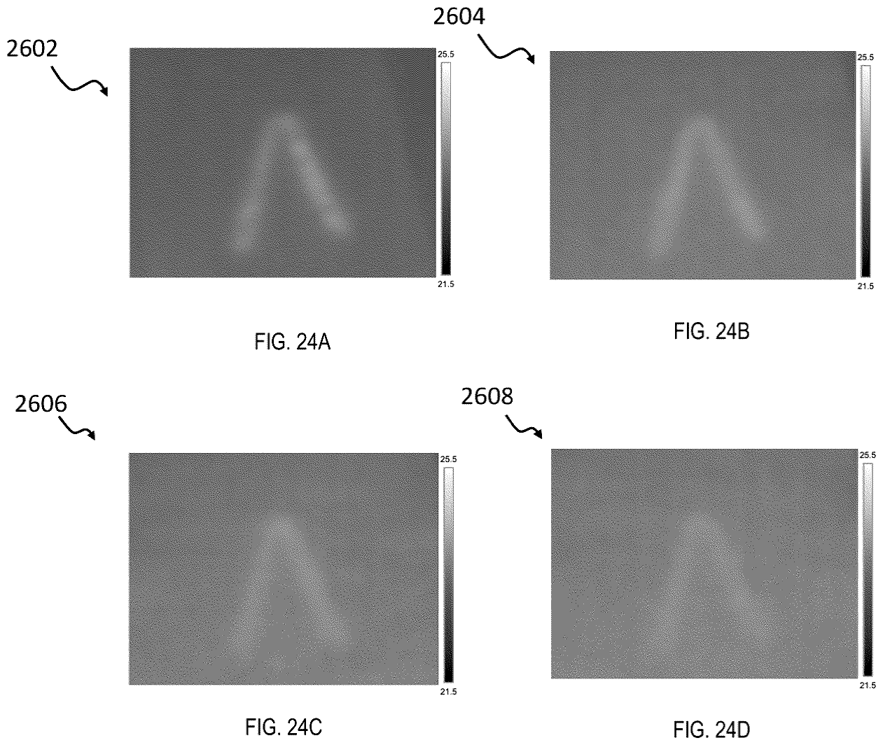

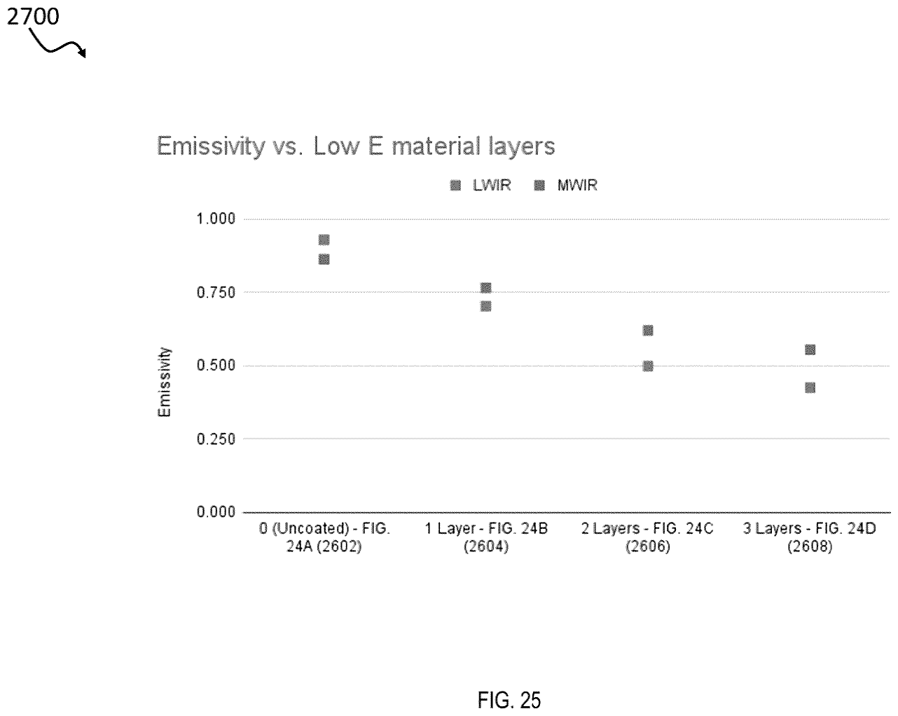

Diffuse reflectance, in the textile 2300 may be varied by varying the number of layers of low emissivity material 2302 that is applied on the substrate 2308. FIGS. 24A-24D illustrate images of diffuse reflectance showing the diffuse reflectance of a representative substrate (e.g., 2308) in four conditions: an uncoated/raw substrate 2602, coated with one layer of low emissivity fabric 2604, with two layers of low emissivity fabric 2606, and with three layers of the low emissivity material 2608. The clarity of the symbol ‘A’ in the image is a qualitative measure of diffuse reflectance. A clearer ‘A’ has a lower diffuse reflectance, meaning that it is more specular. A blurry ‘A’ has high diffuse reflectance, scattering incident IR emissions from a light source in many directions.

Table 1 and FIG. 25 depict the effect of layering low emissivity material on tuning or modifying the final emissivity of a fabric, and the corresponding impact on diffuse reflectance 2700.

TABLE 1
Weights and IR pigment concentrations

| | LWIR | MWIR |
|---|---|---|
| | Emissivity | Emissivity |
| 0 layers (Uncoated) (FIG. 24A-2602) | 0.930 | 0.864 |
| 1 layer (FIG. 24B-2604) | 0.704 | 0.766 |
| 2 layers (FIG. 24C-2606) | 0.499 | 0.621 |
| 3 layers (FIG. 24D-2408) | 0.426 | 0.555 |

The final result is textile 2300, comprising both visual camouflage and IR camouflage through the low emissivity material applied. The low emissivity material 2304, having a high level of transparency to visible light, does not obscure the visual camouflage of layer 2306 over which the low emissivity material 2304 is applied.

In other embodiments, the top layer 2302 may be absent, or the low emissivity material layer 2304 may be modified to comprise the properties of the top layer 2302.

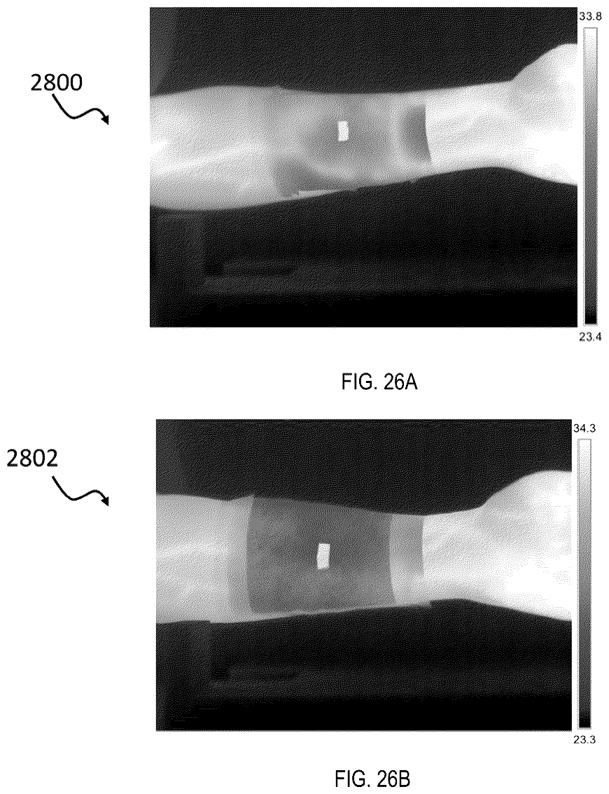

FIGS. 26A and 26B illustrate images showing coated 2800 and uncoated 2802 fabric blocking IR thermal radiation from the body. This IR blocking ability is tunable and therefore can be modified to meet requirements related, but not limited to IR detectors, ambient IR radiation, specific IR sources, and other thermal radiation requirements. FIGS. 26A and 26B, are representative of the ability of embodiments disclosed to block IR thermal radiation with the human body as a source. This can also be used to block other sources of radiation such as, but not limited to military equipment, housings and other sources as identified.

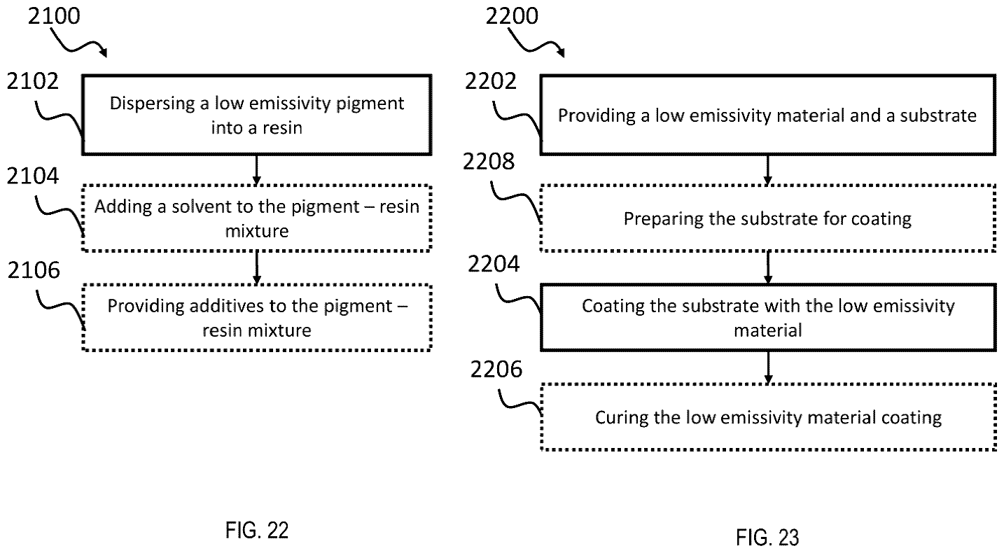

Referring now to FIG. 22, pictured therein is a flow chart depicting a method 2100 of producing the low E materials described herein, according to an embodiment. Method 2100 comprises step 2102, and optionally, 2104 and/or 2106. Description above describing various embodiments of low E materials, compositions, coatings, and applications thereof, may apply to method 2100.

At step 2102, a low emissivity pigment is dispersed into a resin. The pigment may be dispersed by any means described herein, or by any other suitable means.

At step 2104, a solvent is added to the pigment-resin mixture. The solvent may comprise any solvent described herein or any other suitable solvent.

In some examples of method 2100, steps 2104 and 2102 may be combined into a single step, wherein the pigment and resin are each combined with a solvent separately, and then the resin-solvent and pigment solvent mixtures are combined into a single mixture.

At step 2106, additives are provided to the pigment-resin mixture. Additives may include any additives described in this herein disclosure. For example, the additives of step 2106 may comprise leveling agents, catalysts, curing agents, diffusing agents, reactive diluents, surfactants, wetting agents, defoamers, photo-stabilizers, and other additives. In some examples of method 2100, step 2106 may be performed before step 2104.

Referring now to FIG. 23, pictured therein is a flow chart depicting a method 2200 of applying the low E materials described herein as a coating on a substrate, according to an embodiment. Method 2200 comprises steps 2202, and 2204 and optionally, steps 2206 and/or 2208. Description above describing various embodiments of low E coatings, and applications thereof, may apply to method 2200.

At step 2202, a low emissivity material and a substrate are provided. The low emissivity coating and substrate may each comprise any low emissivity coating or material, and substrate respectively described herein.

At step 2204, the low emissivity material is applied onto the substrate as a coating. The coating may be applied to the substrate by any method described herein, or any other method.

Method 2200 may optionally further comprise steps 2206 and 2208. At step 2206, the low emissivity coating is cured. The coating may be cured by any method described herein, or any other suitable method. For example, the coating may be cured by the application of heat, UV or other radiation, or a combination thereof.

Step 2208 may occur before step 2204. At step 2208, the substrate is prepared for coating with the low emissivity material. The preparation of step 2208 may comprise surface cleaning, surface roughening, the application of a primer material or composition or other compound to promote adherence of the coating application of step 2204, the application of an adhesive and/or release liner to an underside of the substrate, or any other preparation steps.

While the above description provides examples of one or more apparatus, methods, or systems, it will be appreciated that other apparatus, methods, or systems may be within the scope of the claims as interpreted by one of skill in the art.

1. A low emissivity material, the material comprising:
a low emissivity pigment, the pigment comprising a conductive nanomaterial; and
a resin;
wherein the pigment is dispersed into the resin, forming a matrix of conductive nanomaterial.

2. The material of claim 1, wherein the pigment comprises a metallic nanomaterial.

3. The material of claim 2, wherein the pigment comprises any one of a silver nanomaterial, copper nanomaterial, iron nanomaterial, aluminum nanomaterial or gold nanomaterial.

4. The material of claim 1, wherein the pigment comprises a conductive polymer nanomaterial.

5. The material of claim 1, wherein the pigment is a 1D nanomaterial.

6. The material of claim 1, wherein the pigment is a 2D nanomaterial.

7. The material of claim 1, wherein the material further comprises a solvent.

8. The material of claim 1, wherein the material further comprises a diffusing agent for scattering infrared radiation.

9. The material of claim 1, wherein the material further comprises a hardening agent.

10. A method of producing a low emissivity material, the method comprising:
dispersing a low emissivity conductive nanomaterial pigment into a resin, producing the low emissivity material.

11. The method of claim 10, further comprising mixing a solvent into the low emissivity material.

12. The method of claim 10, further comprising the forming the low emissivity material into a textile fiber.

13. A method of applying a low emissivity coating to a substrate, the method comprising:
coating a substrate with a low emissivity material comprising a resin and conductive nanomaterial low emissivity pigment.

14. The method of claim 13, the method further comprising curing the low emissivity material after coating the substrate.

15. The method of claim 14, wherein the curing comprises exposing the low emissivity coating material to ultraviolet radiation.

16. The method of claim 14, wherein the curing comprises exposing the low emissivity coating material to an elevated temperature.

17. The method of claim 13, wherein the substrate is further coated with a liner or adhesive.

18. The method of claim 13, wherein applying the low emissivity material to the substrate comprises spin coating the substrate with the material.

19. The method of claim 13, wherein applying the low emissivity material to the substrate comprises pad coating the substrate with the material.

20. The method of claim 13, wherein the substrate comprises a textile.
